(19) United States
(12) Patent Application Publication
(10) Pub. No.: US 2022/0254307 A1
(43) Pub. Date: Aug. 11, 2022

(54) DISPLAY DEVICE

(71) Applicant: LG ELECTRONICS INC., Seoul (KR)

(72) Inventor: Kwonkwon JEONG, Seoul (KR)

(73) Assignee: LG ELECTRONICS INC., Seoul (KR)

(21) Appl. No.: 17/626,894

(22) PCT Filed: Jul. 18, 2019
(86) PCT No.: PCT/KR2019/008894

§ 371 Date: Jan. 13, 2022

(51) Int. Cl. G09G 3/3233

(52) U.S. Cl. CPC G09G 3/3233; G09G 2320/0257; G09G 2300/0452; G09G 2300/0842; G09G 2320/043

(57) ABSTRACT

Disclosed is a display device for minimizing shortening of the lifespan of a white sub-pixel. The display device includes a panel including a plurality of pixels, each of the plurality of pixels including a red sub-pixel, a green sub-pixel, a blue sub-pixel, and a white sub-pixel, and a controller configured to control at least one of the plurality of pixels to repeatedly execute a first mode in which the white sub-pixel is turned on and a second mode in which the white sub-pixel is turned off.

### TECHNICAL FIELD

The present disclosure relates to a display device, and more particularly to a display device using a WRGB method.

### BACKGROUND ART

In recent years, the types of display devices have been diversified. Among them, an organic light emitting diode (OLED) display device is widely used.

Since the OLED display device is a self-luminous device, the OLED display device has lower power consumption and may be made thinner than a liquid crystal display (LCD) requiring a backlight. In addition, the OLED display device has a wide viewing angle and a fast response time.

The OLED display device may be classified into an RGB method and a WRGB method according to an element arrangement structure.

In the RGB method, OLED elements of three primary colors (red, green, and blue) are horizontally arranged on a panel at regular intervals, and the OLED elements of three primary colors emit different colors and constitute one pixel (dot or pixel).

In the WRGB method, one pixel is constructed using an OLED element that emits white light (internally, three primary color elements are vertically stacked, hereinafter referred to as a white OLED element), and then a color filter that transmits the three primary colors is covered thereon to provide various implement color.

In the WRGB method, one pixel includes four sub-pixels, and the four sub-pixels includes a red sub-pixel including a red color filter on the white OLED element, a green sub-pixel including a green color filter on the white OLED element, a blue sub-pixel including a blue color filter on the white OLED element, and a white sub-pixel including the white OLED element without a color filter.

In a pixel driven using the WRGB method, the white sub-pixel needs to be driven to represent all colors except for a primary color (red, green, and blue) and a secondary color (yellow, cyan, and magenta). In addition, a logo of a broadcasting station is often represented in white, and thus there is a problem in that the lifespan of a white sub-pixel is shorter than that of other sub-pixels.

### DISCLOSURE

### Technical Problem

The present disclosure provides a display device for minimizing shortening of the lifespan of a white sub-pixel in a panel driven using a WRGB method.

The present disclosure provides a display device for minimizing a problem in that the lifespan of a white sub-pixel is rapidly reduced compared with those of other red, green, and blue sub-pixels in a panel driven using a WRGB method.

The present disclosure provides a display device for minimizing a problem in terms of an afterimage due to frequency use of a white sub-pixel.

### Technical Solution

According to an embodiment of the present disclosure, a display device includes a panel including a plurality of pixels, each of the plurality of pixels including a red sub-pixel, a green sub-pixel, a blue sub-pixel, and a white sub-pixel, and a controller configured to control at least one of the plurality of pixels to repeatedly execute a first mode in which the white sub-pixel is turned on and a second mode in which the white sub-pixel is turned off.

The controller may adjust pixel data to reproduce the same color by repeatedly executing the first mode and the second mode in at least one of the plurality of pixels.

The controller may adjust pixel data in the first mode and pixel data in the second mode to be different.

The controller may control a pixel to turn on at least the white sub-pixel in the first mode and to turn on at least one of the red sub-pixel, the green sub-pixel, or the blue sub-pixel instead of the white sub-pixel in the second mode.

The controller may control a pixel, in which a lifespan of the white sub-pixel is less than a preset reference lifespan, to repeatedly execute the first mode and the second mode among the plurality of pixels.

The controller may control a pixel, in which a lifespan of the white sub-pixel is equal to or greater than the reference lifespan, to execute only the first mode among the plurality of pixels.

The controller may control at least one pixel to repeatedly execute the first mode and the second mode at a predetermined period.

The controller may control at least one pixel to execute the first mode for a first time and to execute the second mode for a second time.

The controller may acquire each of the first time and the second time depending on a lifespan of each of the red sub-pixel, the green sub-pixel, the blue sub-pixel, and the white sub-pixel.

The controller may control a pixel corresponding to a preset region of a screen to repeatedly execute the first mode and the second mode.

The controller may set a region of a screen, on which a logo is displayed, to a region in which the first mode and the second mode are repeatedly executed.

The controller may control a pixel representing a primary color or a secondary color to execute only the second mode.

The controller may control a pixel representing white or a tertiary color to repeatedly execute the first mode and the second mode.

The controller may control the pixel representing white to turn on only the white sub-pixel in the first mode and to turn on all of the red sub-pixel, the green sub-pixel, and the blue sub-pixel in the second mode.

The controller may control the pixel representing the tertiary color to turn on at least one of the red sub-pixel, the green sub-pixel, or the blue sub-pixel and the white sub-pixel in the first mode and to turn on all of the red sub-pixel, the green sub-pixel, and the blue sub-pixel in the second mode.

### Advantageous Effects

According to an embodiment of the present disclosure, a load of a white sub-pixel may be distributed to red, green, and blue sub-pixels to advantageously reduce shortening of the lifespan of the white sub-pixel. That is, a frequency of use of the white sub-pixel may be reduced, thereby reducing shortening of the lifespan of the white sub-pixel.

According to an embodiment of the present disclosure, a problem in that the lifespan of a white sub-pixel is rapidly shortened compared with that of other red, green, and blue sub-pixels may be advantageously minimized.

According to an embodiment of the present disclosure, an afterimage due to shortening of the lifespan of the white sub-pixel may be minimized, thereby advantageously reducing afterimage visibility.

### DESCRIPTION OF DRAWINGS

FIG. 1 is a diagram illustrating a display device according to an embodiment of the present disclosure.

FIG. 2 is an example of a block diagram of the inside of the display device in FIG. 1.

FIG. 3 is an example of a block diagram of the inside of a controller in FIG. 2.

FIG. 4A is a diagram illustrating a method in which the remote controller in FIG. 2 performs control.

FIG. 4B is a block diagram of the inside of the remote controller in FIG. 2.

FIG. 5 is a block diagram of the inside of the display in FIG. 2.

FIGS. 6A and 6B are diagrams that are referred to for description of the OLED panel in FIG. 5.

FIG. 7 is a diagram for explaining a method of controlling a pixel of a panel by a display device according to an embodiment of the present disclosure.

FIG. 8 is a diagram for explaining a method of adjusting pixel data in a display device according to an embodiment of the present disclosure.

FIG. 9 is a diagram for explaining a method of controlling only some pixels to repeatedly execute a first mode and a second mode by a display device according to another embodiment of the present disclosure.

FIG. 10 is a flowchart of a method of acquiring a target pixel and controlling the target pixel by a display device according to an embodiment of the present disclosure.

### BEST MODE

Hereinafter, the present disclosure will be described in detail with reference to the drawings.

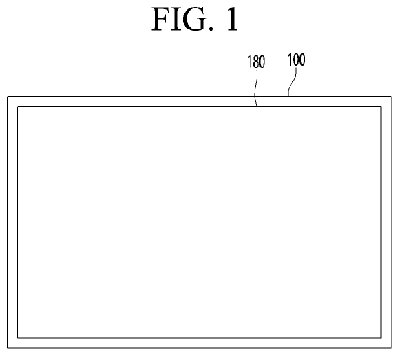

FIG. 1 is a diagram illustrating a display device according to an embodiment of the present disclosure.

With reference to the drawings, a display device 100 includes a display 180.

On the other hand, the display 180 is realized by one among various panels. For example, the display 180 is one of the following panels: a liquid crystal display panel (LCD panel), an organic light-emitting diode (OLED) panel (OLED panel), and an inorganic light-emitting diode (OLED) panel (ILED panel).

According to the present disclosure, the display 180 is assumed to include an organic light-emitting diode (OLED) panel (OLED). It should be noted that this is only exemplary, and the display 180 may include a panel other than an organic light emitting diode panel (OLED panel).

On the other hand, examples of the display device 100 in FIG. 1 include a monitor, a TV, a tablet PC, a mobile terminal, and so on.

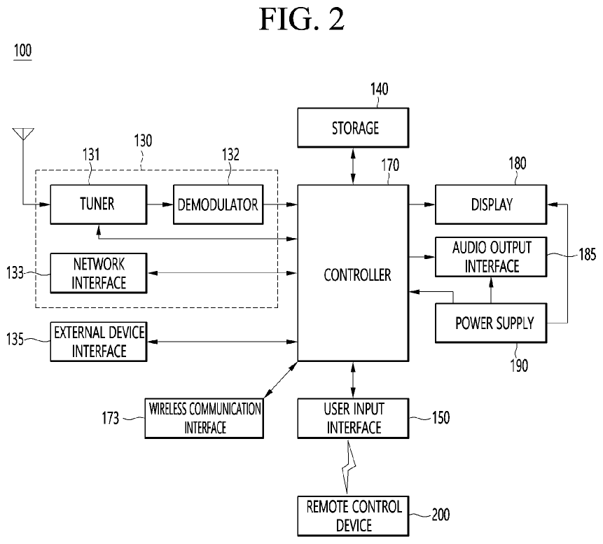

FIG. 2 is an example of a block diagram of the inside of the display device in FIG. 1.

With reference to FIG. 2, a display device 100 may include a broadcast reception module 130, an external device interface 135, a storage 140, a user input interface 150, a controller 170, a wireless communication interface 173, a voice acquisition module 175, a display 180, an audio output interface 185, and a power supply 190.

The broadcast reception module 130 may include a tuner 131, a demodulator 132, and a network interface 133.

The tuner 131 may select a specific broadcast channel according to a channel selection command. The tuner 131 may receive broadcast signals for the selected specific broadcast channel.

The demodulator 132 may divide the received broadcast signals into video signals, audio signals, and broadcast program related data signals and restore the divided video signals, audio signals, and data signals to an output available form.

The network interface 133 may provide an interface for connecting the display device 100 to a wired/wireless network including internet network. The network interface 133 may transmit or receive data to or from another user or another electronic device through an accessed network or another network linked to the accessed network.

The network interface 133 may access a predetermined webpage through an accessed network or another network linked to the accessed network. That is, it may transmit or receive data to or from a corresponding server by accessing a predetermined webpage through network.

Then, the network interface 133 may receive contents or data provided from a content provider or a network operator. That is, the network interface 133 may receive contents such as movies, advertisements, games, VODs, and broadcast signals, which are provided from a content provider or a network provider, through network and information relating thereto.

Additionally, the network interface 133 may receive firmware update information and update files provided from a network operator and transmit data to an internet or content provider or a network operator.

The network interface 133 may select and receive a desired application among applications open to the air, through network.

The external device interface 135 may receive an application or an application list in an adjacent external device and deliver it to the controller 170 or the storage 140.

The external device interface 135 may provide a connection path between the display device 100 and an external device. The external device interface 135 may receive at least one of image and audio outputted from an external device that is wirelessly or wiredly connected to the display device 100 and deliver it to the controller. The external device interface 135 may include a plurality of external input terminals. The plurality of external input terminals may include an RGB terminal, at least one High Definition Multimedia Interface (HDMI) terminal, and a component terminal.

An image signal of an external device inputted through the external device interface 135 may be outputted through the display 180. A sound signal of an external device inputted through the external device interface 135 may be outputted through the audio output interface 185.

An external device connectable to the external device interface 135 may be one of a set-top box, a Blu-ray player, a DVD player, a game console, a sound bar, a smartphone, a PC, a USB Memory, and a home theater system but this is just exemplary.

Additionally, some content data stored in the display device 100 may be transmitted to a user or an electronic device, which is selected from other users or other electronic devices pre-registered in the display device 100.

The storage 140 may store signal-processed image, voice, or data signals stored by a program in order for each signal processing and control in the controller 170.

Additionally, the storage 140 may perform a function for temporarily store image, voice, or data signals outputted from the external device interface 135 or the network interface 133 and may store information on a predetermined image through a channel memory function.

The storage 140 may store an application or an application list inputted from the external device interface 135 or the network interface 133.

The display device 100 may play content files (for example, video files, still image files, music files, document files, application files, and so on) stored in the storage 140 and provide them to a user.

The user input interface 150 may deliver signals inputted from a user to the controller 170 or deliver signals from the controller 170 to a user. For example, the user input interface 150 may receive or process control signals such as power on/off, channel selection, and screen setting from the remote control device 200 or transmit control signals from the controller 170 to the remote control device 200 according to various communication methods such as Bluetooth, Ultra Wideband (WB), ZigBee, Radio Frequency (RF), and IR.

Additionally, the user input interface 150 may deliver, to the controller 170, control signals inputted from local keys (not shown) such as a power key, a channel key, a volume key, and a setting key.

Image signals that are image-processed in the controller 170 may be inputted to the display 180 and displayed as an image corresponding to corresponding image signals. Additionally, image signals that are image-processed in the controller 170 may be inputted to an external output device through the external device interface 135.

Voice signals processed in the controller 170 may be outputted to the audio output interface 185. Additionally, voice signals processed in the controller 170 may be inputted to an external output device through the external device interface 135.

Besides that, the controller 170 may control overall operations in the display device 100.

Additionally, the controller 170 may control the display device 100 by a user command or internal program inputted through the user input interface 150 and download a desired application or application list into the display device 100 in access to network.

The controller 170 may output channel information selected by a user together with processed image or voice signals through the display 180 or the audio output interface 185.

Additionally, according to an external device image playback command received through the user input interface 150, the controller 170 may output image signals or voice signals of an external device such as a camera or a camcorder, which are inputted through the external device interface 135, through the display 180 or the audio output interface 185.

Moreover, the controller 170 may control the display 180 to display images and control broadcast images inputted through the tuner 131, external input images inputted through the external device interface 135, images inputted through the network interface, or images stored in the storage 140 to be displayed on the display 180. In this case, an image displayed on the display 180 may be a still image or video and also may be a 2D image or a 3D image.

Additionally, the controller 170 may play content stored in the display device 100, received broadcast content, and external input content inputted from the outside, and the content may be in various formats such as broadcast images, external input images, audio files, still images, accessed web screens, and document files.

Moreover, the wireless communication interface 173 may perform a wired or wireless communication with an external electronic device. The wireless communication interface 173 may perform short-range communication with an external device. For this, the wireless communication interface 173 may support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication interface 173 may support wireless communication between the display device 100 and a wireless communication system, between the display device 100 and another display device 100, or between networks including the display device 100 and another display device 100 (or an external server) through wireless area networks. The wireless area networks may be wireless personal area networks.

Herein, the other display device 100 may be a mobile terminal such as a wearable device (for example, a smart watch, a smart glass, and a head mounted display (HMD)) or a smartphone, which is capable of exchanging data (or inter-working) with the display device 100. The wireless communication interface 173 may detect (or recognize) a communicable wearable device around the display device 100. Furthermore, if the detected wearable device is a device authenticated to communicate with the display device 100, the controller 170 may transmit at least part of data processed in the display device 100 to the wearable device through the wireless communication interface 173. Accordingly, a user of the wearable device may use the data processed in the display device 100 through the wearable device.

The display 180 may convert image signals, data signals, or OSD signals, which are processed in the controller 170, or images signals or data signals, which are received in the external device interface 135, into R, G, and B signals to generate driving signals.

Furthermore, the display device 100 shown in FIG. 2 is just one embodiment of the present disclosure and thus, some of the components shown may be integrated, added, or omitted according to the specification of the actually implemented display device 100.

That is, if necessary, two or more components may be integrated into one component or one component may be divided into two or more components and configured. Additionally, a function performed by each block is to describe an embodiment of the present disclosure and its specific operation or device does not limit the scope of the present disclosure.

According to another embodiment of the present disclosure, unlike FIG. 2, the display device 100 may receive images through the network interface 133 or the external device interface 135 and play them without including the tuner 131 and the demodulator 132.

For example, the display device 100 may be divided into an image processing device such as a set-top box for receiving broadcast signals or contents according to various network services and a content playback device for playing contents inputted from the image processing device.

In this case, an operating method of a display device according to an embodiment of the present disclosure described below may be performed by one of the display device described with reference to FIG. 1, an image processing device such as the separated set-top box, and a content playback device including the display 180 and the audio output interface 185.

The audio output interface 185 receives the audio processed signal from the controller 170 and outputs the sound.

The power supply 190 supplies the corresponding power throughout the display device 100. In particular, the power supply 190 supplies power to the controller 170 that may be implemented in the form of a System On Chip (SOC), a display 180 for displaying an image, and the audio output interface 185 for outputting audio or the like.

Specifically, the power supply 190 may include a converter for converting an AC power source into a DC power source, and a DC/DC converter for converting a level of the DC source power.

The remote controller 200 transmits a user input to the user input interface 150. To do this, the remote controller 200 employs Bluetooth, radio frequency (RF) communication, infrared (IR) communication, ultra-wideband (UWB), a ZigBee specification, and so on. In addition, the remote controller 200 receives an image signal, an audio signal, or a data signal output from the user input interface 150, and displays the received signal on a display of the remote controller 200 or outputs the received signal, as audio, to an output interface of the remote controller 200.

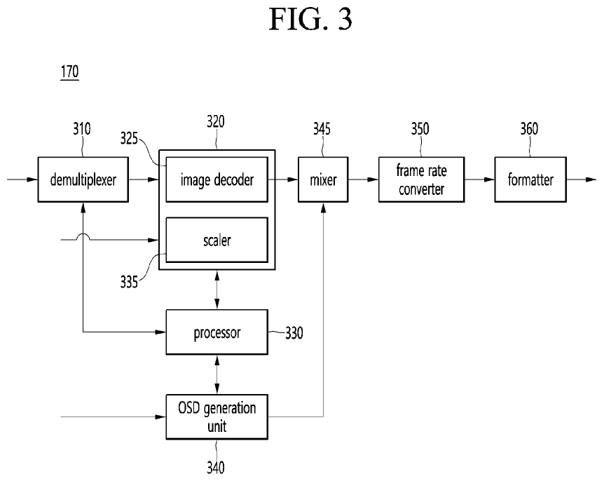

FIG. 3 is an example of a block diagram of the inside of a controller in FIG. 2.

For description with reference to the drawings, the controller 170 according to an embodiment of the present disclosure includes a demultiplexer 310, an image processor 320, a processor 330, an OSD generator 340, a mixer 345, a frame rate converter 350, and a formatter 360. In addition, an audio processor (not illustrated) and a data processor (not illustrated) are further included.

The demultiplexer 310 demultiplexes a stream input. For example, in a case where an MPEG-2 TS is input, the MPEG-2 TS is demultiplexed into an image signal, an audio signal, and a data signal. At this point, a stream signal input into the demultiplexer 310 is a stream signal output from the tuner 131, the demodulator 132, or the external device interface 135.

The image processor 320 performs image processing of the image signal that results from the demultiplexing. To do this, the image processor 320 includes an image decoder 325 or a scaler 335.

The image decoder 325 decodes the image signal that results from the demultiplexing. The scaler 335 performs scaling in such a manner that a resolution of an image signal which results from the decoding is such that the image signal is possibly output to the display 180.

Examples of the image decoder 325 possibly include decoders in compliance with various specifications. For example, the examples of the image decoder 325 include a decoder for MPEG-2, a decoder for H.264, a 3D image decoder for a color image and a depth image, a decoder for a multi-point image, and so on.

The processor 330 controls an overall operation within the display device 100 or within the controller 170. For example, the processor 330 controls the tuner 110 in such a manner that the tuner 110 performs the selection of (tuning to) the RF broadcast that corresponds to the channel selected by the user or the channel already stored.

In addition, the processor 330 controls the display device 100 using the user command input through the user input interface 150, or the internal program.

In addition, the processor 330 performs control of transfer of data to and from the network interface 133 or the external device interface 135.

In addition, the processor 330 controls operation of each of the demultiplexer 310, the image processor 320, the OSD generator 340, and so on within the controller 170.

The OSD generator 340 generates an OSD signal, according to the user input or by itself. For example, based on the user input signal, a signal is generated for displaying various pieces of information in a graphic or text format on a screen of the display 180. The OSD signal generated includes various pieces of data for a user interface screen of the display device 100, various menu screens, a widget, an icon, and so on. In addition, the OSD generated signal includes a 2D object or a 3D object.

In addition, based on a pointing signal input from the remote controller 200, the OSD generator 340 generates a pointer possibly displayed on the display. Particularly, the pointer is generated in a pointing signal processor, and an OSD generator 340 includes the pointing signal processor (not illustrated). Of course, it is also possible that instead of being providing within the OSD generator 340, the pointing signal processor (not illustrated) is provided separately.

The mixer 345 mixes the OSD signal generated in the OSD generator 340, and the image signal that results from the image processing and the decoding in the image processor 320. An image signal that results from the mixing is provided to the frame rate converter 350.

The frame rate converter (FRC) 350 converts a frame rate of an image input. On the other hand, it is also possible that the frame rate converter 350 outputs the image, as is, without separately converting the frame rate thereof.

On the other hand, the formatter 360 converts a format of the image signal input, into a format for an image signal to be displayed on the display, and outputs an image that results from the conversion of the format thereof.

The formatter 360 changes the format of the image signal. For example, a format of a 3D image signal is changed to any one of the following various 3D formats: a side-by-side format, a top and down format, a frame sequential format, an interlaced format, and a checker box format.

On the other hand, the audio processor (not illustrated) within the controller 170 performs audio processing of an audio signal that results from the demultiplexing. To do this, the audio processor (not illustrated) includes various decoders.

In addition, the audio processor (not illustrated) within the controller 170 performs processing for base, treble, volume adjustment and so on.

The data processor (not illustrated) within the controller 170 performs data processing of a data signal that results from the demultiplexing. For example, in a case where a data signal that results from the demultiplexing is a data signal the results from coding, the data signal is decoded. The data signal that results from the coding is an electronic program guide that includes pieces of broadcast information, such as a starting time and an ending time for a broadcast program that will be telecast in each channel.

On the other hand, a block diagram of the controller 170 illustrated in FIG. 3 is a block diagram for an embodiment of the present disclosure. Each constituent element in the block diagram is subject to integration, addition, or omission according to specifications of the image display controller 170 actually realized.

Particularly, the frame rate converter 350 and the formatter 360 may be provided separately independently of each other or may be separately provided as one module, without being provided within the controller 170.

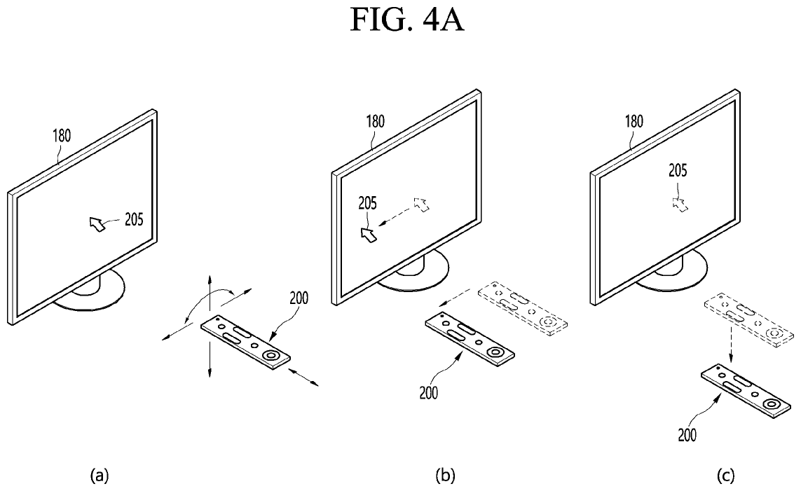

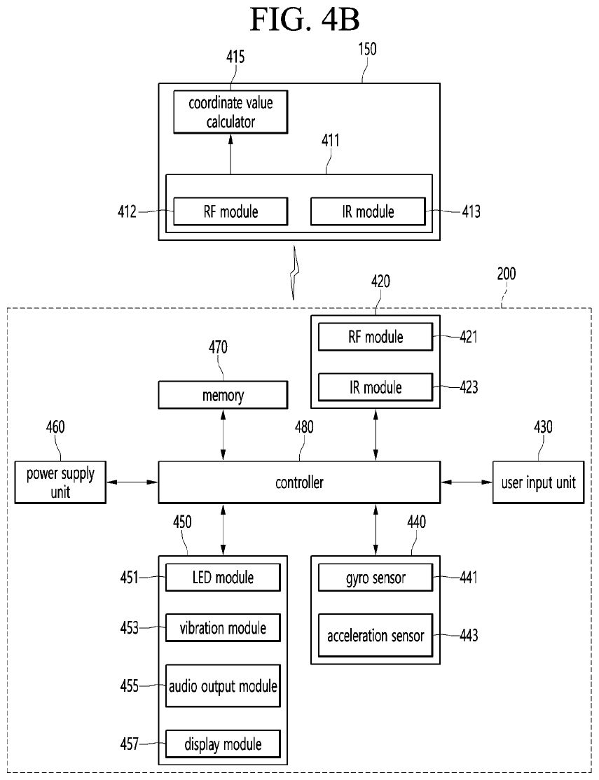

FIG. 4A is a diagram illustrating a method in which the remote controller in FIG. 2 performs control.

In FIG. 4A(a), it is illustrated that a pointer 205 which corresponds to the remote controller 200 is displayed on the display 180.

The user moves or rotates the remote controller 200 upward and downward, leftward and rightward (FIG. 4A(b)), and forward and backward (FIG. 4A(c)). The pointer 205 displayed on the display 180 of the display device corresponds to movement of the remote controller 200. As in the drawings, movement of the pointer 205, which depends on the movement of the remote controller 200 in a 3D space, is displayed and thus, the remote controller 200 is named a spatial remote controller or a 3D pointing device.

FIG. 4A(b) illustrates that, when the user moves the remote controller 200 leftward, the pointer 205 displayed on the display 180 of the display device correspondingly moves leftward.

Information on the movement of the remote controller 200, which is detected through a sensor of the remote controller 200, is transferred to the display device. The display device calculates the information on the movement of the remote controller 200 from coordinates of the pointer 205. The display device displays the pointer 205 in such a manner that the pointer 25 corresponds to the calculated coordinates.

FIG. 4A(c) illustrates a case where the user moves the remote controller 200 away from the display 180 in a state where a specific button within the remote controller 200 is held down. Accordingly, a selection area within the display 180, which corresponds to the pointer 205, is zoomed in so that the selection area is displayed in an enlarged manner. Conversely, in a case where the user causes the remote controller 200 to approach the display 180, the selection area within the display 180, which corresponds to the pointer 205, is zoomed out so that the selection is displayed in a reduced manner. On the other hand, in a case where the remote controller 200 moves away from the display 180, the selection area may be zoomed out, and in a case where the remote controller 200 approaches the display 180, the selection area may be zoomed in.

On the other hand, an upward or downward movement, or a leftward or rightward movement is not recognized in a state where a specific button within the remote controller 200 is held down. That is, in a case where the remote controller 200 moves away from or approaches the display 180, only a forward or backward movement is set to be recognized without the upward or downward movement, or the leftward or rightward movement being recognized. Only the pointer 205 moves as the remote controller 200 moves upward, downward, leftward, or rightward, in a state where a specific button within the remote controller 200 is not held down.

On the other hand, a moving speed or a moving direction of the pointer 205 corresponds to a moving speed or a moving direction of the remote controller 200, respectively.

FIG. 4B is a block diagram of the inside of the remote controller in FIG. 2.

For description with reference to the drawings, the remote controller 200 includes a wireless communicator 420, a user input interface 430, a sensor 440, an output interface 450, a power supply 460, a memory 470, and a controller 480.

The wireless communicator 420 transmits and receives a signal to and from an arbitrary one of the display devices according to the embodiments of the present disclosure, which are described above. Of the display devices according to the embodiments of the present disclosure, one display device is taken as an example for description.

According to the present embodiment, the remote controller 200 includes an RF module 421 that transmits and receives a signal to and from the display device 100 in compliance with RF communication standards. In addition, the remote controller 200 includes an IR module 423 that possibly transmits and receives a signal to and from the display device 100 in compliance with IR communication standards.

According to the present embodiment, the remote controller 200 transfers a signal containing information on the movement of the remote controller 200 to the display device 100 through the RF module 421.

In addition, the remote controller 200 receives a signal transferred by the display device 100, through the RF module 421. In addition, the remote controller 200 transfers a command relating to power-on, power-off, a channel change, or a volume change, to the display device 100, through the IR module 423, whenever needed.

The user input interface 430 is configured with a keypad, buttons, a touch pad, a touch screen, or so on. The user inputs a command associated with the display device 100 into the remote controller 200 by operating the user input interface 430. In a case where the user input interface 430 is equipped with a physical button, the user inputs the command associated with the display device 100 into the remote controller 200 by performing an operation of pushing down the physical button. In a case where the user input interface 430 is equipped with a touch screen, the user inputs the command associated with the display device 100 into the remote controller 200 by touching on a virtual key of the touch screen. In addition, the user input interface 430 may be equipped with various types of input means operated by the user, such as a scroll key or a jog key, and the present embodiment does not impose any limitation on the scope of the present disclosure.

The sensor 440 includes a gyro sensor 441 or an acceleration sensor 443. The gyro sensor 441 senses information on the movement of the remote controller 200.

As an example, the gyro sensor 441 senses the information on operation of the remote controller 200 on the x-, y-, and z-axis basis. The acceleration sensor 443 senses information on the moving speed and so on of the remote controller 200. On the other hand, a distance measurement sensor is further included. Accordingly, a distance to the display 180 is sensed.

The output interface 450 outputs an image or an audio signal that corresponds to the operating of the user input interface 430 or corresponds to a signal transferred by the display device 100. Through the output interface 450, the user recognizes whether or not the user input interface 430 is operated or whether or not the display device 100 is controlled.

As an example, the output interface 450 includes an LED module 451, a vibration module 453, an audio output module 455, or a display module 457. The LED module 451, the vibration module 453, the audio output module 455, and the display module 457 emits light, generates vibration, outputs audio, or outputs an image, respectively, when the input interface 435 is operated, or a signal is transmitted and received to and from the display device 100 through a wireless communicator 420.

The power supply 460 supplies a power to the remote controller 200. In a case where the remote controller 200 does not move for a predetermined time, the power supply 460 reduces power consumption by interrupting power supply. In a case where a predetermined key provided on the remote controller 200 is operated, the power supply 460 resumes the power supply.

Various types of programs, pieces of application data, and so on that are necessary for control or operation of the remote controller 200 are stored in the memory 470. In a case where the remote controller 200 transmits and receives a signal to and from the display device 100 in a wireless manner through the RF module 421, the signal is transmitted and received in a predetermined frequency band between the remote controller 200 and the display device 100. The controller 480 of the remote controller 200 stores information on, for example, a frequency band in which data is transmitted and received in a wireless manner to and from the display device 100 paired with the remote controller 200, in the memory 470, and makes a reference to the stored information.

The controller 480 controls all operations associated with the control by the remote controller 200. The controller 480 transfers a signal that corresponds to operating of a predetermined key of the user input interface 430, or a signal that corresponds to the movement of the remote controller 200, which is sensed in the sensor 440, to the display device 100 through the wireless communicator 420.

A user input interface 150 of the display device 100 includes a wireless communicator 411 that transmits and receives a signal in a wireless manner to and from the remote controller 200, and a coordinate value calculator 415 that calculates a coordinate value of the pointer, which corresponds to the operation of the remote controller 200.

The user input interface 150 transmits and receives the signal in a wireless manner to and from the remote controller 200 through the RF module 412. In addition, a signal transferred in compliance with the IR communication standards by the remote controller 200 through the IR module 413 is received.

The coordinate value calculator 415 calculates a coordinate value (x, y) of the pointer 205 to be displayed on the display 180, which results from compensating for a hand movement or an error, from a signal that corresponds to the operation of the remote controller 200, which is received through the wireless communicator 411.

A transfer signal of the remote controller 200, which is input into the display device 100 through the user input interface 150 is transferred to the controller 170 of the display device 100. The controller 170 determines information on the operation of the remote controller 200 and information on operating of a key, from the signal transferred by the remote controller 200, and correspondingly controls the display device 100.

As another example, the remote controller 200 calculates a coordinate value of a pointer, which corresponds to the operation of the remote controller 200, and outputs the calculated value to the user input interface 150 of the display device 100. In this case, the user input interface 150 of the display device 100 transfers information on the received coordinate values of the pointer, to the controller 170, without performing a process of compensating for the hand movement and the error.

In addition, as another example, unlike in the drawings, it is also possible that the coordinate value calculator 415 is included within the controller 170 instead of the user input interface 150.

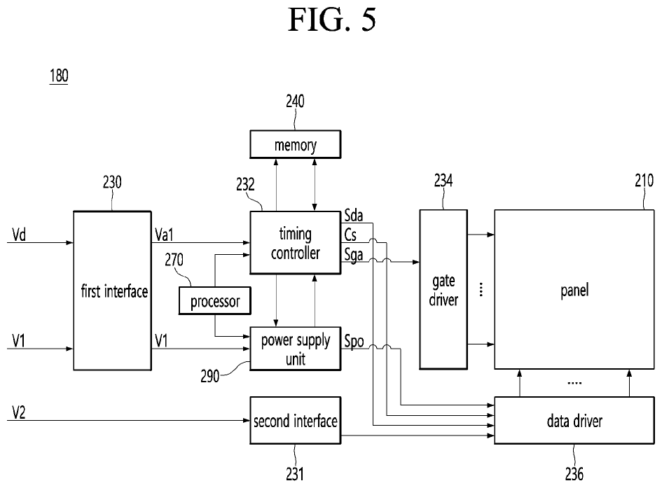

FIG. 5 is a block diagram of the inside of the display in FIG. 2.

With reference with the drawings, the display 180 based on the organic light-emitting diode may include the OLED panel 210, a first interface 230, a second interface 231, a timing controller 232, a gate driver 234, a data driver 236, a memory 240, a processor 270, a power supply 290, and so on.

The display 180 receives an image signal Vd, a first direct current power V1, and a second direct current power V2. Based on the image signal Vd, the display 180 display a predetermined image is displayed.

On the other hand, the first interface 230 within the display 180 receives the image signal Vd and the first direct current power V1 from the controller 170.

At this point, the first direct current power V1 is used for operation for each of the power supply 290 and the timing controller 232 within the display 180.

Next, the second interface 231 receives the second direct current power V2 from the external power supply 190. On the other hand, the second direct current power V2 is input into the data driver 236 within the display 180.

Based on the image signal Vd, the timing controller 232 outputs a data drive signal Sda and a gate drive signal Sga.

For example, in a case where the first interface 230 converts the image signal Vd input, and outputs image signal val that results from the conversion, the timing controller 232 outputs the data drive signal Sda and the gate drive signal Sga based on the image signal val that results from the conversion.

The timing controller 232 further receives a control signal, the vertical synchronization signal Vsync, and so on, in addition to a video signal Vd from the controller 170.

The timing controller 232 outputs the gate drive signal Sga for operation of the gate driver 234 and the data drive signal Sda for operation of the data driver 236, based on the control signal, the vertical synchronization signal Vsync, and so on in addition to the video signal Vd.

In a case where the OLED panel 210 includes a subpixel for RGBW, the data drive signal Sda at this time is a data drive signal for a subpixel for RGBW.

On the other hand, the timing controller 232 further outputs a control signal Cs to the gate driver 234.

The gate driver 234 and the data driver 236 supplies a scanning signal and an image signal to the OLED panel 210 through a gate line GL and a data line DL according to the gate drive signal Sga and the data drive signal Sda, respectively, from the timing controller 232. Accordingly, a predetermined image is displayed on the OLED panel 210.

On the other hand, the OLED panel 210 includes an organic light-emitting layer. In order to display an image, many gate lines GL and many data lines DL are arranged to intersect each other in a matrix form, at each pixel that corresponds to the organic light-emitting layer.

On the other hand, the data driver 236 outputs a data signal to the OLED panel 210 based on the second direct current power V2 from the second interface 231.

The power supply 290 supplies various types of powers to the gate driver 234, the data driver 236, the timing controller 232, and so on.

The processor 270 performs various types of control within the display 180. For example, the gate driver 234, the data driver 236, the timing controller 232, and so on are controlled.

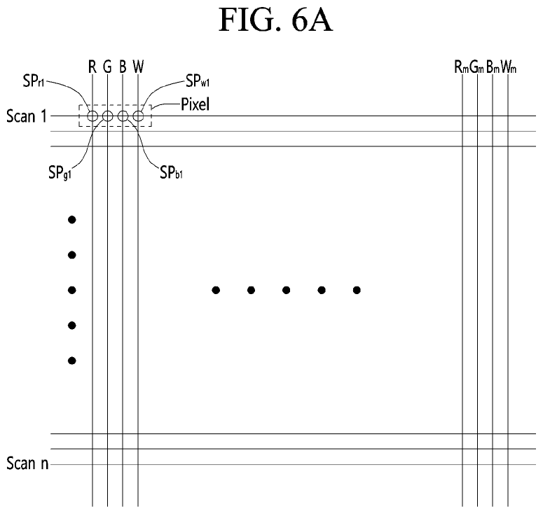

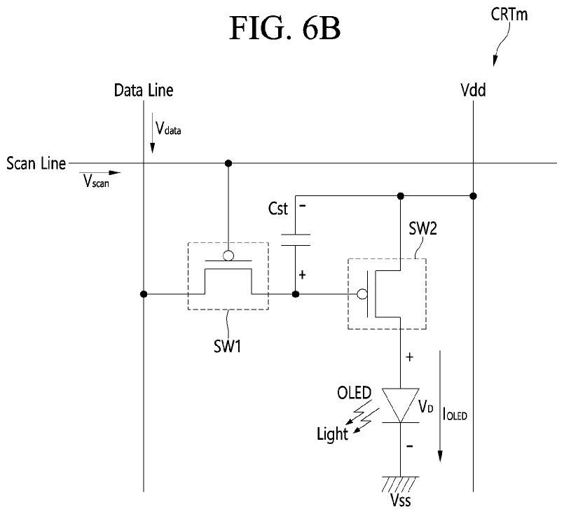

FIGS. 6A and 6B are diagrams that are referred to for description of the OLED panel in FIG. 5.

First, FIG. 6A is a diagram illustrating a pixel within a panel 210. The panel 210 may be an OLED panel.

With reference to the drawings, the OLED panel 210 includes a plurality of scan lines Scan 1 to Scan n and a plurality of data lines R1, G1, B1, W1 to Rm, Gm, Bm, Wm that intersect a plurality of scan lines Scan 1 to Scan n, respectively.

On the other hand, an area where the scan line and the data line within the OLED panel 210 intersect each other is defined as a subpixel. In the drawings, a pixel that includes a subpixel SPr1, SPg1, SPb1, SPw1 for RGBW is illustrated.

FIG. 6B illustrates a circuit of one subpixel within the OLED panel in FIG. 6A.

With reference to the drawings, an organic light-emitting subpixel circuit CRTm includes a switching element SW1, a storage capacitor Cst, a drive switching element SW2, and an organic light-emitting layer (OLED), which are active-type elements.

A scan line is connected to a gate terminal of the scan switching element SW1. The scanning switching element SW1 is turned on according to a scan signal Vscan input. In a case where the scan switching element SW1 is turned on, a data signal Vdata input is transferred to the gate terminal of the scan switching element SW2 or one terminal of the storage capacitor Cst.

The storage capacitor Cst is formed between the gate terminal and a source terminal of the drive switching element SW2. A predetermined difference between a data signal level transferred to one terminal of the storage capacitor Cst and a direct current (Vdd) level transferred to the other terminal of the storage capacitor Cst is stored in the storage capacitor Cst.

For example, in a case where data signals have different levels according to a pulse amplitude modulation (PAM) scheme, power levels that are stored in the storage capacitor Cst are different according to a difference between levels of data signals Vdata.

As another example, in a case where data signals have different pulse widths according to a pulse width modulation (PWM) scheme, power levels that are stored in the storage capacitor Cst are different according to a difference between pulse widths of data signals Vdata.

The drive switching element SW2 is turned on according to the power level stored in the storage capacitor Cst. In a case where the drive switching element SW2 is turned on, a drive electric current (IOLED), which is in proportion to the stored power level, flows through the organic light-emitting layer (OLED). Accordingly, the organic light-emitting layer (OLED) performs a light-emitting operation.

The organic light-emitting layer (OLED) includes a light-emitting layer (EML) for RGBW, which corresponds to a subpixel, and includes at least one of the following layers: a hole implementation layer (HIL), a hole transportation layer (HTL), an electron transportation layer (ETL), and an electron implementation layer (EIL). In addition to these, the organic light-emitting layer includes a hole support layer and so on.

On the other hand, when it comes to a subpixel, the organic light-emitting layer outputs while light, but in the case of the subpixels for green, red, and blue, a separate color filter is provided in order to realize color. That is, in the case of the subpixels for green, red, and blue, color filters for green, red, and blue, respectively, are further provided. On the other hand, in the case of the subpixel for white, white light is output and thus a separate color filter is unnecessary.

On the other hand, in the drawings, as the scan switching element SW1 and the drive switching element SW2, p-type MOSFETs are illustrated, but it is also possible that n-type MOSFETs, or switching elements, such as JETs, IGBTs, or SICs, are used.

As such, the panel 210 may include a plurality of pixels, and each of the plurality of pixels may include a red sub-pixel, a green sub-pixel, a blue sub-pixel, and a white sub-pixel.

In this case, the white sub-pixel may be used more frequently than other red, green, and blue sub-pixels.

Specifically, when a pixel represents a primary color, only one of a red sub-pixel, a green sub-pixel, and a blue sub-pixel may be driven. For example, when red is represented, only the red sub-pixel may be driven, when green is represented, only the green sub-pixel may be driven, and when blue is represented, only the blue sub-pixel may be driven.

When a pixel represents a secondary color, only two of the red sub-pixel, the green sub-pixel, and the blue sub-pixel may be driven. For example, when yellow is represented, only the red sub-pixel and the green sub-pixel may be driven, when cyan is represented, only the green sub-pixel and the blue sub-pixel may be driven, and when magenta is represented, only the blue sub-pixel and the red sub-pixel may be driven.

That is, when a pixel represents a primary color or a secondary color, other sub-pixels except for the white sub-pixel may be driven. However, in most cases, the pixel may represent colors other than primary and secondary colors rather than representing a primary or secondary color, and in this case, the white sub-pixel may be mainly used.

For example, when a pixel represents white, only the white sub-pixel may be driven.

When a pixel represents colors other than primary and secondary colors and white, at least one of red, green, or blue sub-pixels and a white sub-pixel may be driven together. This is because, for example, when pixel data of an input image is RGB (170, 225, 100), the panel 210 is controlled according to the pixel data converted into RGBW (70, 155, 0 100).

In the present disclosure, WRGB, RGBW, RWBG, etc. are merely described in a different order for convenience of explanation.

For this reason, shortening of the lifetime of the white sub-pixel may be accelerated than that of other sub-pixels. Thus, shortening of the lifetime of the white sub-pixel of the display device 100 according to an embodiment of the present disclosure may slow down.

In particular, in the display device 100 according to an embodiment of the present disclosure, a load of the white sub-pixel may be distributed to at least one of the other red, green, or blue sub-pixels, thereby minimizing shortening of the lifespan of the white sub-pixel.

Hereinafter, a method for improving the lifespan of the white sub-pixel in the display device 100 according to an embodiment of the present disclosure will be described.

According to an embodiment of the present disclosure, the controller 170 may control at least one of a plurality of pixels to repeatedly execute a first mode in which a white sub-pixel is turned on and a second mode in which the white sub-pixel is turned off. Hereinafter, an operation in which the first mode and the second mode are repeatedly executed in a pixel will be described in detail.

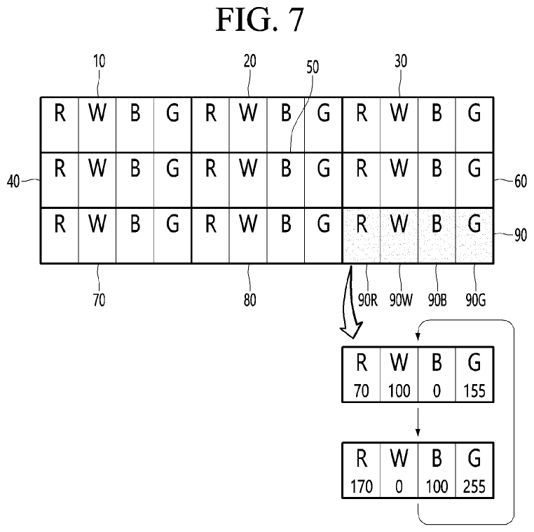

FIG. 7 is a diagram for explaining a method of controlling a pixel of a panel by a display device according to an embodiment of the present disclosure.

A plurality of pixels 10, 20, 30, . . . , and 90 may be arranged on the panel 210. Although FIG. 7 illustrates the case in which nine pixels are arranged on the panel 210, this is merely an example for convenience of explanation. That is, the number of pixels provided in the panel 210 may vary.

A red sub-pixel, a white sub-pixel, a blue sub-pixel, and a green sub-pixel may be provided in each of the plurality of pixels 10, 20, 30, . . . , and 90. FIG. 7 illustrates the case in which the white sub-pixel is disposed between the red sub-pixel and the blue sub-pixel, and the blue sub-pixel is disposed between the white sub-pixel and the green sub-pixel, this is also merely an example for convenience of explanation. That is, the number of sub-pixels included in one pixel may vary.

The controller 170 may control any one of the plurality of pixels 10, 20, 30, . . . , and 90 to repeatedly execute the first mode and the second mode. In the example of FIG. 7, the controller 170 may control the ninth pixel 90 of the first to ninth pixels 10, 20, 30, . . . , and 90 to repeatedly execute the first mode and the second mode.

The first mode may be a mode in which the white sub-pixel is turned on, and the second mode may be a mode in which the white sub-pixel is turned off.

The first mode may be a mode in which driving current flows in an organic light emitting layer of the white sub-pixel, and the second mode may be a mode in which driving current does not flow in the organic light emitting layer of the white sub-pixel.

The first mode may be a mode that is controlled by pixel data adjusted to drive the white sub-pixel, and the second mode may be a mode that is controlled by pixel data adjusted not to drive the white sub-pixel.

The controller 170 may adjust the pixel data to represent the same color by repeatedly executing the first mode and the second mode in a plurality of pixels. The controller 170 may differently adjust pixel data in the first mode and pixel data in the second mode.

The controller 170 may directly convert pixel data of each of pixels included in the panel 210. Alternatively, the controller 170 may also control the timing controller 232 to convert pixel data of each of the pixels included in the panel 210.

When pixel data is RGB (r, g, b), the controller 170 may generate a minimum value (min) of r, g, and b as a data value of the white sub-pixel, may convert the data value into RGBW (r-min, g-min, b-min, min) by subtracting the minimum value (min) from each of r, g, and b, and may adjust RGBW (r-min, g-min, b-min, min) to pixel data in the first mode and may adjust RGBW (r, g, b, 0) to pixel data in the second mode.

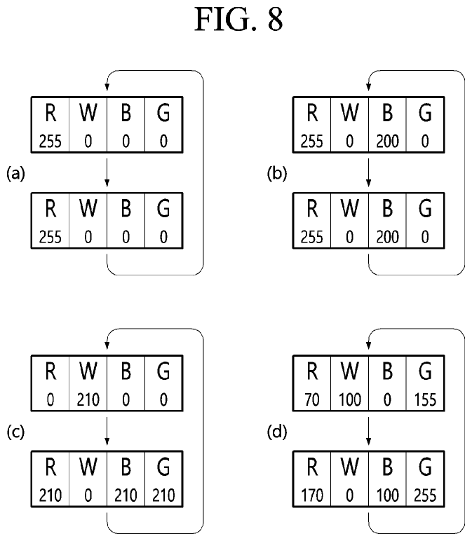

FIG. 8 is a diagram for explaining a method of adjusting pixel data in a display device according to an embodiment of the present disclosure.

FIG. 8A illustrates a method of adjusting pixel data when a pixel represents a primary color, FIG. 8B illustrates a method of adjusting pixel data when a pixel represents a secondary color, FIG. 8C illustrates a method of adjusting pixel data when a pixel represents white, and FIG. 8D illustrates a method of adjusting pixel data when a pixel represents a tertiary color.

In the present disclosure, the primary color may refer to red, green, and blue, the secondary color may refer to color (yellow, cyan, and magenta) obtained by mixing primary colors, and the tertiary color may refer to color obtained by mixing the primary color and the secondary color.

Referring to FIG. 8A, the controller 170 may control a pixel representing a primary color to execute only the second mode.

Referring to FIG. 8B, the controller 170 may control a pixel representing a secondary color to execute only the second mode.

That is, the controller 170 may control the pixel representing the primary color or the secondary color to drive only at least one of a red sub-pixel, a green sub-pixel, or a blue sub-pixel.

Referring to FIG. 8C, the controller 170 may control a pixel representing white to repeatedly execute the first mode and the second mode. For example, the controller 170 may control the pixel representing white to be driven by RGBW (0, 0, 0, 210) in the first mode and to be driven by RGBW (210, 210, 210, 0) in the second mode.

That is, the controller 170 may control the pixel representing white to turn on only the white sub-pixel in the first mode and to turn on all of the red sub-pixel, the green sub-pixel, and the blue sub-pixel in the second mode.

Referring to FIG. 8D, the controller 170 may control a pixel representing a tertiary color to repeatedly execute the first mode and the second mode. For example, when pixel data is RGB (170, 225, 100), the controller 170 may generate a minimum value, 100 to a data value of the white sub-pixel, may adjust RGBW (70, 155, 0, 100) to pixel data in the first mode, and may adjust RGBW (170, 225, 100, 0) to pixel data in the second mode.

That is, the controller 170 may control the pixel representing a tertiary color to turn on at least one of the red sub-pixel, the green sub-pixel, or the blue sub-pixel and the white sub-pixel in the first mode and to turn on all of the red sub-pixel, the green sub-pixel, and the blue sub-pixel in the second mode.

As such, the controller 170 may control a pixel to turn on at least the white sub-pixel in the first mode and to turn on at least one of the red sub-pixel, the green sub-pixel, or the blue sub-pixel instead of the white sub-pixel in the second mode.

Referring back to the example of FIG. 7, the controller 170 may receive RGB (170, 255, 100) as pixel data of the ninth pixel 90. In this case, the controller 170 may control the ninth pixel 90 to repeatedly execute the first mode and the second mode rather than being controlled only by RGBW (170, 255, 100, 0).

That is, the controller 170 may control the ninth pixel 90 to repeatedly execute the first mode in which pixel data is controlled by RGBW (70, 155, 0, 100) and the second mode in which pixel data is controlled by RGBW (170, 255, 100, 0).

In this case, a color represented in the first mode by the ninth pixel 90 and a color represented in the second mode by the ninth pixel 90 may be the same. That is, a difference between a color represented by a pixel in the first mode and a color represented by the pixel in the second mode may be at a level that is difficult for a user to perceive.

Accordingly, when a pixel represents a specific color, the case in which the white sub-pixel (90W) is continuously turned on may be minimized, thereby minimizing shortening of the lifetime of the white sub-pixel.

According to an embodiment, the controller 170 may control at least one pixel to repeatedly execute the first mode and the second mode at a predetermined period.

That is, the controller 170 may control at least one pixel to alternately and repeatedly execute the first mode and the second mode. In this case, an operating time in the first mode and an operating time in the second mode may be the same.

In this case, the period may be T1(ms), T2(s), or T(m). That is, the period may be set to vary.

According to another embodiment, the controller 170 may control at least one pixel to operate in the first mode for a first time and to operate in the second mode for a second time. In this case, the first time and the second time may be different.

In this case, the controller 170 may acquire the first time and the second time depending on the lifetime of each of the red sub-pixel, the green sub-pixel, the blue sub-pixel, and the white sub-pixel. For example, the controller 170 may set the second time to be longer than the first time when an average lifespan of the red sub-pixel, the green sub-pixel, and the blue sub-pixel is longer than the lifespan of the white sub-pixel, and may set the first time to be longer than the second time when the average lifespan of the red sub-pixel, the green sub-pixel, and the blue sub-pixel to be shorter than the lifespan of the white sub-pixel. However, this is merely an example, and the controller 170 may set each of the first time and the second time using various methods.

The controller 170 may also set the first time to be shorter than the second time irrespective of the remaining lifespan of sub-pixels.

The display 180 may further include a current detector (not shown) for detecting current flowing in a sub-pixel of the panel 210. The controller 170 may calculate cumulative current of each sub-pixel based on information on current defected by the current detector (not shown) and may calculate the lifespan of each sub-pixel based on the cumulative current.

For example, when the cumulative current of the sub-pixel is less than 100,000 A, the controller 170 may acquire the remaining lifespan of the sub-pixel as a time N1, when the cumulative current of the sub-pixel is less than 200,000 A, the controller 170 may acquire the remaining lifespan of the sub-pixel as a time N2 shorter than the time N1, and when the cumulative current of the sub-pixel is less than 300,000 A, the controller 170 may acquire the remaining lifespan of the sub-pixel as a time N3 shorter than the time N2.

However, this is merely an example, and the controller 170 may calculate the lifespan of each sub-pixel using various methods.

The controller 170 may separately control pixels included in the panel 210.

In this case, according to an embodiment, the controller 170 may control the pixels included in the panel 210 to repeatedly execute the first mode and the second mode based on input pixel data.

According to another embodiment, the controller 170 may control some of the pixels included in the panel 210 to repeatedly execute the first mode and the second mode and may control the other pixels to execute only the first mode or the second mode.

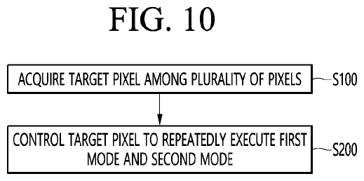

In this case, some pixels controlled to execute the first mode and the second mode may be a target pixel. The target pixel will be described in detail with reference to FIG. 10.

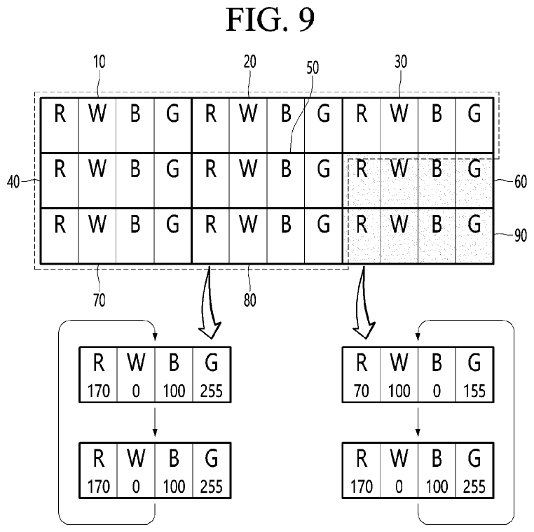

FIG. 9 is a diagram for explaining a method of controlling only some pixels to repeatedly execute a first mode and a second mode by a display device according to another embodiment of the present disclosure.

Referring to an example of FIG. 9, the controller 170 may control the panel 210 to execute only the second mode in first to fifth and seventh to eighth pixels 10 to 50, and 70 to 80 and to repeatedly execute the first mode and the second mode in sixth and ninth pixels 60 and 90. Differently from the example of FIG. 9, the controller 170 may also control the first to fifth and seventh to eighth pixels 10 to 50, and 70 to 80 to execute only the first mode.

Referring to the example of FIG. 9, the first to fifth and seventh to eighth pixels 10 to 50, and 70 to 80 may be controlled by RGBW (170, 255, 100, 0), and the sixth and ninth pixels 60 and 90 may be controlled to repeatedly realize RGBW (170, 255, 100, 0) and RGBW (70, 155, 0, 100). In this case, all of the first to ninth pixels 10 to 90 may represent the same color.

As such, the controller 170 may control only some of a plurality of pixels included in the panel 210 to repeatedly execute the first mode and the second mode to reproduce color. In this case, it is not required to adjust pixel data of all pixels, and thus a burden of pixel data conversion may be advantageously reduced.

FIG. 10 is a flowchart of a method of acquiring a target pixel and controlling the target pixel by a display device according to an embodiment of the present disclosure.

The controller 170 may acquire the target pixel among a plurality of pixels included in the panel 210 and may control only the target pixel to repeatedly execute the first mode and the second mode.

The controller 170 may acquire a target pixel among a plurality of pixels (S100).

Here, the target pixel may refer to a pixel, the lifespan of a white sub-pixel of which needs to be improved. In detail, the panel 210 may include a plurality of pixels, and the plurality of pixels are separately driven, and thus there may be a pixel in which a frequency of use of a white sub-pixel is relatively high, and in contrast, there may be a pixel in which a frequency of use of a white sub-pixel is relatively low. Accordingly, the controller 170 may acquire the pixel in which the frequency of use of a white sub-pixel is relatively high as the target pixel among the plurality of pixels.

According to a first embodiment, the controller 170 may acquire a pixel in which the lifespan of a white sub-pixel is less than a preset reference lifespan as the target pixel among the plurality of pixels. That is, the controller 170 may control the pixel in which the lifespan of the white sub-pixel is less than a preset reference lifespan to repeatedly execute the first mode and the second mode among the plurality of pixels. The controller 170 may control the pixel in which the lifespan of the white sub-pixel is equal to or greater than the reference lifespan to execute only the first mode among the plurality of pixels.

According to a second embodiment, the controller 170 may control a pixel corresponding to a preset region of a screen to repeatedly execute the first mode and the second mode. That is, the controller 170 may control a pixel corresponding to a preset region among pixels of the panel 210 to repeatedly execute the first mode and the second mode and may control a pixel corresponding to the remaining region except for the preset region to execute only one of the first mode and the second mode.

For example, the controller 170 may set a region for displaying a logo from a screen on which an image is displayed by the panel 210 to a region in which the first mode and the second mode are repeatedly executed. However, this is merely an example, and the controller 170 may set various regions of the panel 210 to a region in which the first mode and the second mode are repeatedly executed.

The controller 170 may also acquire the target pixel using other methods except for the first and second embodiments.

The controller 170 may control the target pixel to repeatedly execute the first mode and the second mode (S200).

As such, according to the present embodiment, when white is represented, the controller 170 may switch a white sub-pixel and red, green, and blue sub-pixels, and thus may distribute a load of the white sub-pixel to the other red, green, and blue sub-pixels.

Similarly, even if a white component is contained, the controller 170 may turn on the red, green, and blue sub-pixels instead of the white sub-pixel and may reduce output the red, green, and blue sub-pixels using the white sub-pixel when a predetermined time elapses, thereby reducing the load of the white sub-pixel.

The above description is merely illustrative of the technical idea of the present disclosure, and various modifications and changes may be made thereto by those skilled in the art without departing from the essential characteristics of the present disclosure.

Therefore, the embodiments of the present disclosure are not intended to limit the technical spirit of the present disclosure but to illustrate the technical idea of the present disclosure, and the technical spirit of the present disclosure is not limited by these embodiments.

The scope of protection of the present disclosure should be interpreted by the appending claims, and all technical ideas within the scope of equivalents should be construed as falling within the scope of the present disclosure.

1. A display device comprising:
a panel including a plurality of pixels, each of the plurality of pixels including a red sub-pixel, a green sub-pixel, a blue sub-pixel, and a white sub-pixel; and
a controller configured to control at least one of the plurality of pixels to repeatedly execute a first mode in which the white sub-pixel is turned on and a second mode in which the white sub-pixel is turned off.

2. The display device of claim 1, wherein the controller adjusts pixel data to reproduce the same color by repeatedly executing the first mode and the second mode in at least one of the plurality of pixels.

3. The display device of claim 2, wherein the controller adjusts pixel data in the first mode and pixel data in the second mode to be different.

4. The display device of claim 1, wherein the controller controls a pixel to turn on at least the white sub-pixel in the first mode and to turn on at least one of the red sub-pixel, the green sub-pixel, or the blue sub-pixel instead of the white sub-pixel in the second mode.

5. The display device of claim 1, wherein the controller controls a pixel, in which a lifespan of the white sub-pixel is less than a preset reference lifespan, to repeatedly execute the first mode and the second mode among the plurality of pixels.

6. The display device of claim 5, wherein the controller controls a pixel, in which a lifespan of the white sub-pixel is equal to or greater than the reference lifespan, to execute only the first mode among the plurality of pixels.

7. The display device of claim 1, wherein the controller controls at least one pixel to repeatedly execute the first mode and the second mode at a predetermined period.

8. The display device of claim 1, wherein the controller controls at least one pixel to execute the first mode for a first time and to execute the second mode for a second time.

9. The display device of claim 8, wherein the controller acquires each of the first time and the second time depending on a lifespan of each of the red sub-pixel, the green sub-pixel, the blue sub-pixel, and the white sub-pixel.

10. The display device of claim 1, wherein the controller controls a pixel corresponding to a preset region of a screen to repeatedly execute the first mode and the second mode.

11. The display device of claim 10, wherein the controller sets a region of a screen, on which a logo is displayed, to a region in which the first mode and the second mode are repeatedly executed.

12. The display device of claim 1, wherein the controller controls a pixel representing a primary color or a secondary color to execute only the second mode.

13. The display device of claim 1, wherein the controller controls a pixel representing white or a tertiary color to repeatedly execute the first mode and the second mode.

14. The display device of claim 13, wherein the controller controls the pixel representing white to turn on only the white sub-pixel in the first mode and to turn on all of the red sub-pixel, the green sub-pixel, and the blue sub-pixel in the second mode.

15. The display device of claim 13, wherein the controller controls the pixel representing the tertiary color to turn on at least one of the red sub-pixel, the green sub-pixel, or the blue sub-pixel and the white sub-pixel in the first mode and to turn on all of the red sub-pixel, the green sub-pixel, and the blue sub-pixel in the second mode.
